(19) United States
(12) Patent Application Publication
(10) Pub. No.: US 2026/0269558 A1
(43) Pub. Date: Sep. 10, 2026

(54) FREQUENCY COMB STABILIZATION USING COMBINED DETECTION

(71) Applicant: ColdQuanta, Inc., Boulder, CO (US)

(72) Inventors: Eng Hiang Mark Yeo, Lakewood, CO (US); Enrico Ridente, Oxford (GB); Robert James Fasano, Boulder, CO (US)

(21) Appl. No.: 19/554,211

(22) Filed: Mar. 2, 2026

Related U.S. Application Data
(60) Provisional application No. 63/768,320, filed on Mar. 7, 2025.

(51) Int. Cl. H01S 3/13; G02F 1/35; H01S 3/0941; H01S 3/137

(52) U.S. Cl. CPC H01S 3/1305; G02F 1/353; H01S 3/0941; H01S 3/137; G02F 2203/56

(57) ABSTRACT

A system for stabilizing a frequency comb includes an oscillator that produces optical pulses with a frequency comb spectrum. The system comprises two control loops having radio frequency (RF) setpoints. The first control loop stabilizes the carrier offset frequency of the frequency comb spectrum at the first RF setpoint, while the second control loop stabilizes a spectral component of the frequency comb spectrum at the second RF setpoint. A photodetector is shared by both control loops and receives optical signals from each loop. The photodetector generates an electrical RF signal, comprising multiple electronic heterodyne signals, which are used by the respective control loops.

### PRIORITY

This application claims the benefit of priority to U.S. Provisional Patent Application Ser. No. 63/768,320, filed Mar. 7, 2025, which is incorporated by reference herein in its entirety.

### BACKGROUND

Optical atomic clocks are precise timekeeping devices that use the quantum transitions of atoms to measure time. These clocks may operate by probing atomic transitions using laser light and locking the laser frequency to the atomic resonance. A clock signal is provided by using a frequency comb to convert the laser light in the optical domain to an electrical signal in the radio-frequency domain.

### BRIEF DESCRIPTION OF THE DRAWINGS

To easily identify the discussion of any particular element or act, the most significant digit or digits in a reference number refer to the figure number in which that element is first introduced.

FIG. 1 illustrates a block diagram of an optical clock.

FIG. 2 illustrates a control diagram for a fully stabilized frequency comb spectrum.

FIG. 3 illustrates a block diagram for frequency comb stabilization using combined detection.

FIG. 4 illustrates a method for frequency comb stabilization using combined detection.

FIG. 5 illustrates relative frequencies of optical spectra combined for frequency comb stabilization.

FIG. 6 illustrates relative frequencies of optical spectra combined for frequency comb stabilization.

FIG. 7 illustrates an optical spectrum broadened by a nonlinear optical component.

### DETAILED DESCRIPTION

An atomic clock may include the following:
i) an atomic system,
ii) a local oscillator,
iii) interactions between the local oscillator and the atoms,
iv) detection of the frequency error between the local oscillator and a specified energy transition of the atoms (‘clock transition’), and
v) correction of the frequency error, bringing the local oscillator into agreement with the frequency of the clock transition.

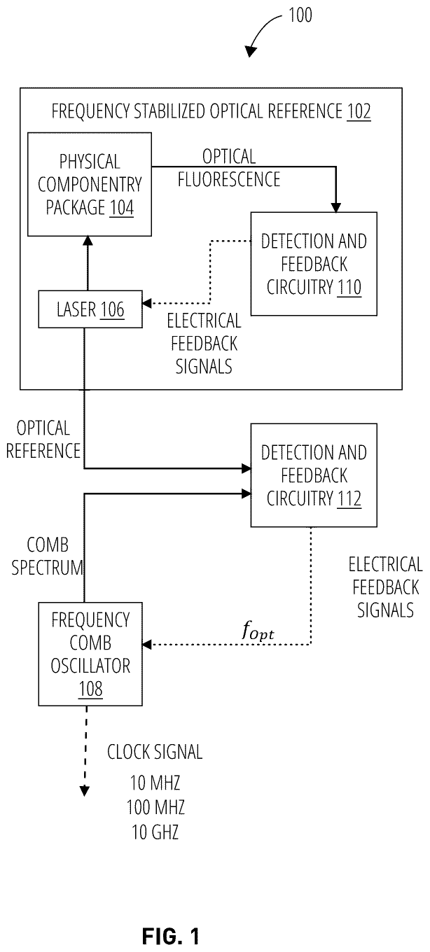

Atomic clocks may use a clock transition (e.g., hyperfine splitting energy levels) that is in the radiofrequency (RF) electrical domain. Thus, atomic clocks may output an electrical clock signal that is able to interface with electronic components. In contrast, an optical atomic clock, such as that shown in FIG. 1, may operate at optical frequencies (e.g., using an atomic energy level transition in the hundreds of THz), and therefore a conversion mechanism from optical (e.g., hundreds of THz) to RF frequencies can be included in an optical atomic clock. A frequency comb system (e.g., an optical system which outputs a frequency comb spectra) can be a useful mechanism for such conversion, as the frequency comb system can output the RF electrical clock signal. In particular, the RF electrical signal can be output from the frequency comb system with enough precision to be used as a clock signal when mechanisms to stabilize the frequency comb are implemented.

FIG. 1 illustrates a block diagram of an optical clock 100. Optical atomic clock 100 can include a frequency stabilized optical reference 102, frequency comb oscillator 108, and detection and feedback circuitry 112.

The frequency stabilized optical reference 102 can include a physical componentry package 104 (e.g., the atomic system), laser 106 (e.g., the local oscillator), circuitry 110 to detect optical fluorescence from the physical componentry package 104, and to provide an electrical feedback signal to the laser 106.

The laser 106 may be tunable or otherwise frequency-selectable across a certain wavelength range, or frequency range. For example, an external cavity diode laser may be tuned by adjusting the position or angle of external cavity mirrors. Any suitable laser technology may be used in laser 106.

The laser 106 may be optically coupled to the physical componentry package 104, and when the frequency of the laser 106 is tuned, atoms in the physical componentry package 104 may interact with the laser 106. For example, the physical componentry package 104 may include a thermal vapor, an ultracold gas, or any other suitable preparation of atoms (e.g., trapped ions), or a mechanical optical frequency reference such as an optical cavity implemented with any suitable cavity technology (e.g., stabilized mirrors in any suitable geometry, micro-resonator or photonic cavity in a photonic integrated circuit, etc.). When the laser 106 is resonant with an energy transition (or cavity mode) in the atoms (mechanical resonator) located in the physical componentry package, the atoms may transition from a ground state to a clock state. When the atoms cascade back down to the ground state, the atoms may emit fluorescence, which can be detected by detection and feedback circuitry 110. The fluorescence may be used to generate an error signal, and the error signal may be anti-symmetric around the center frequency of the fluorescence signal. That is, when the laser 106 is detuned to have a frequency slightly less than the maximum intensity of the fluorescence signal, the error signal may be positive. When the laser 106 is detuned to have a frequency slightly more than the maximum intensity of the fluorescence signal, the error signal may be negative.

The error signal can be input to a proportional-integral-derivative (PID) or other controller, such as can be included in the detection and feedback circuitry 110. The error signal can be a stabilization signal that can be used to control the laser 106. That is, the laser 106 may be locked to the atomic energy transition selected as the clock transition.

The spectrum of light output from the laser 106 may be more stable (e.g., have a smaller linewidth, less frequency noise, etc.) once the laser 106 is locked to the atomic energy transition. The laser output may be converted from a signal in the optical domain to an electrical signal in the radio-frequency domain using the frequency comb oscillator 108 to down-convert the frequency of the stabilized laser signal. The frequency comb oscillator 108 may include electronic signal conditioning to further convert the comb's repetition rate fᵣₑₚ to one or more other frequencies of interest. An output electrical signal from the frequency comb oscillator 108 may include a range of frequencies encompassing ones of MHz, tens of MHz, hundreds of MHz, ones of GHz, tens of GHz, and hundreds of GHz, or combinations thereof, as illustrative examples.

The frequency comb oscillator 108 may comprise an ultra-fast pulsed laser that has a frequency spectrum of a series of evenly spaced narrow lines, each of which may be referred to as a ‘comb tooth’. Overall, the frequency spectrum of frequency comb oscillator 108 may be referred to as a frequency comb spectrum. The repetition rate fᵣₑₚ of pulses output from the ultra fast pulsed laser may set the spacing of the comb teeth (e.g., spectral components) in the frequency comb spectrum. The repetition rate fᵣₑₚ may be detected using a photodiode to provide an output electrical signal that may be used as a timing reference.

As shown in FIG. 1, the frequency comb has one degree of freedom (optical frequency) controlled through closed-loop feedback comprising detection and feedback circuitry 112. In particular, the stabilized optical reference can be heterodyned with the comb spectrum at detection and feedback circuitry 112. The circuitry 112 can generate an error signal based on a beat note detected between the stabilized optical reference and a comb tooth of the comb spectrum that is closest in frequency to the stabilized optical reference. The error signal can be input to the frequency comb oscillator to, e.g., adjust a current of the ultra-fast pulsed laser.

In some examples, the frequency comb oscillator 108, and thus the output electrical signal, may be provided the stability and accuracy of the frequency stabilized optical reference 102 by stabilizing (e.g., using closed-loop feedback) more than one degree of freedom (e.g., two degrees of freedom) of the frequency comb spectrum. These two degrees of freedom can include a) the carrier envelope offset frequency (f_{CEO}) and b) the beat note between the laser 106 and the closest comb tooth (f_{Opt}), discussed above. Each degree of freedom may have a corresponding control loop, and techniques to combine portions of the respective control loops for controlling a frequency comb may be advantageous. For example, a photo-mixing technique and a method of selecting set point values to generate f_{CEO} and f_{Opt} beat notes at a photodetector common to both control loops are presented herein.

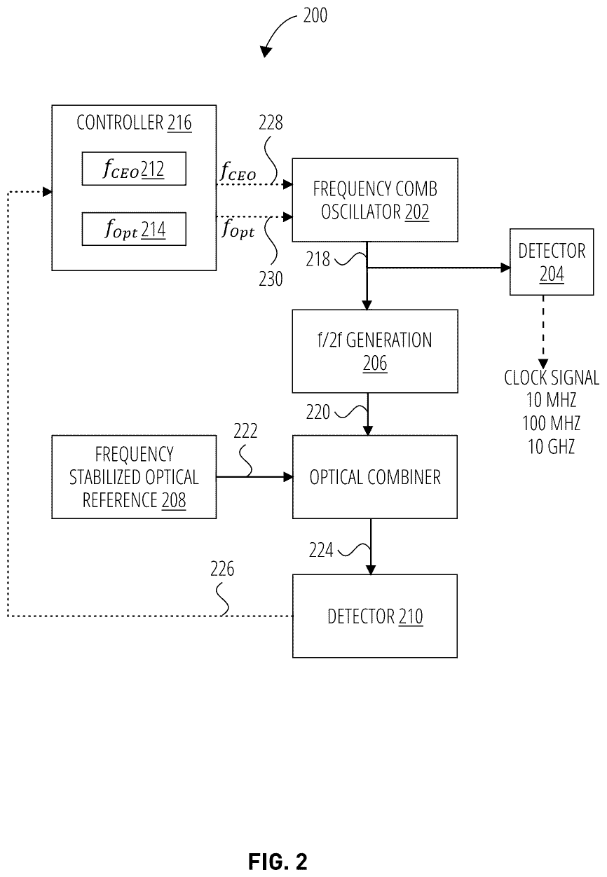

FIG. 2 illustrates a control diagram for a system 200 to fully stabilize a frequency comb spectrum. As noted above, the control diagram may include two control loops that have a portion of respective control loop common to both. The components of system 200 are described followed by a description of respective control loops.

The system 200 can include a frequency comb oscillator 202, an f/2f generation 206, a detector 204, a frequency stabilized optical reference 208, a detector 210, a f_{CEO} 212, a f_{Opt} 214, and a controller 216. Components of the system 200 are connected by optical signals having optical spectra 218 through 224, and electrical signals 226 through 230.

In an example, the frequency comb oscillator 202 may include a mode-locked femto-second (fs) laser system. For example, the frequency comb oscillator 202 may generate a train of pulses, a given pulse having a pulse width of approximately 200 fs, with a pulse spacing of fᵣₑₚ. A frequency spectrum of a pulse from the train of pulses may be centered at any suitable optical wavelength (e.g., visible, near-infrared, telecommunication), and may have an optical spectrum 218 of a frequency comb.

The frequency comb oscillator 202 may generate pulses that are uninterrupted, optically coherent, and have low timing-jitter. The train of pulses output from frequency comb oscillator 202 may propagate through the rest of the system 200. As an example, the train of pulses may be split (e.g., through an intensity-splitting beam splitter, pulse-picker, etc.) such that a first portion of the pulses are directed to detector 204 for detection of fᵣₑₚ (e.g., as an output clock signal) and a second portion of pulses remain in the system 200.

Pulses that remain in the system 200 can be used to measure the carrier offset frequency by using f/2f interferometry at f/2f generation 206. A portion of the optical spectra generated for use in the f/2f interferometry may also be used to generate a heterodyne signal with frequency stabilized optical reference 208.

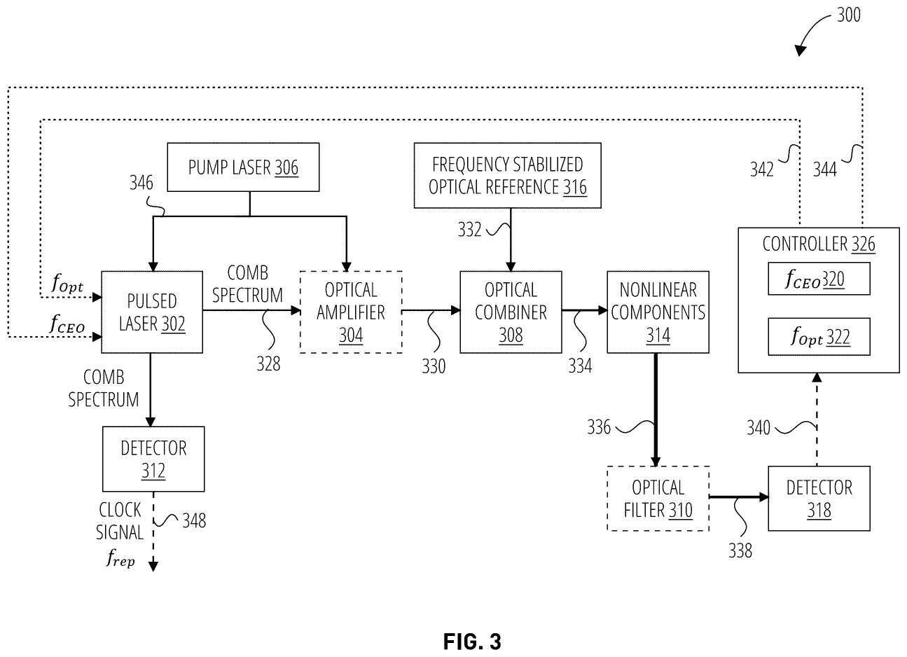

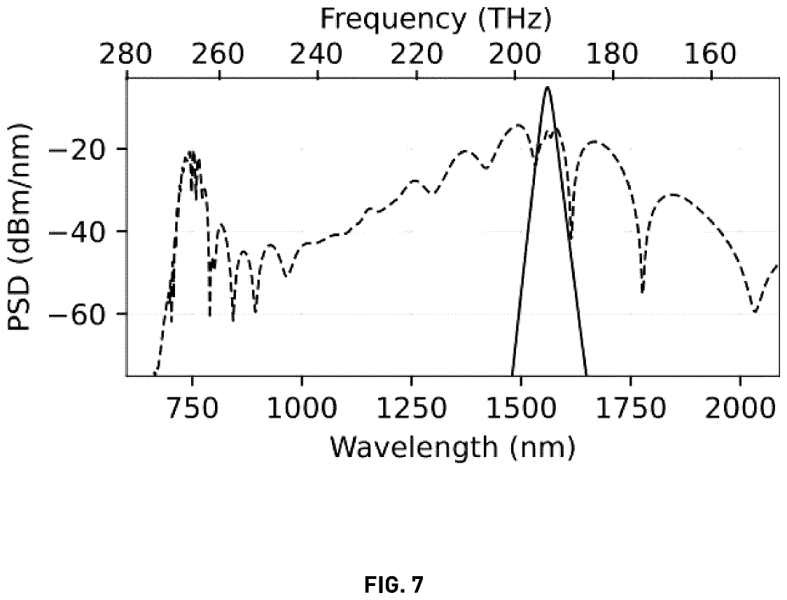

In an example, the f/2f generation 206 may include one or more optically non-linear elements that output one or more optical spectra. Examples of non-linear elements are discussed further below with respect to FIG. 3. In some examples, f/2f generation 206 may output a frequency-doubled optical spectrum 220 relative to the input optical spectra (e.g., the train of pulses having optical spectrum 218). In some examples, f/2f generation 206 may output a broadened optical spectrum 220. That is, in some examples, optical spectrum 220 may resemble f/2f spectrum 704 of FIG. 7 when the optical spectrum 218 has a spectrum shown by pulse spectrum 702 of FIG. 7.

In an example, the frequency stabilized optical reference 208 may include a physical componentry package, a continuous wave laser, and detection/feedback circuitry, such as described above with respect to FIG. 1. In particular, an optical spectrum 222 may overlap with a portion of the optical spectrum 220. In some examples, the optical spectrum 222 may be a laser locked to an optical transition of an atomic vapor (e.g., the D2 line of ⁸⁷Rb or any other suitable energy transition). In an example, the frequency stabilized optical reference 208 may include any stabilized continuous-wave (CW) optical source, such as an optical cavity with a hyperfine transition.

In an example, the optical spectrum 220 and optical spectrum 222 may be combined in an optical combiner (e.g., beamsplitter cube used in beam combiner mode, fiber optic beam combiner, etc.).

In an example, the detector 210 may produce a photocurrent when the combined optical spectrum 220 and optical spectrum 222 are incident on the detector 210. In an example, the photocurrent may include one or more beat notes as a result of heterodyne mixing at the photodetector. For example, the optical spectrum 220 may result in a beat note as a result of heterodyne mixing of spectra from f/2f generation 206. As another example, heterodyne mixing between the optical spectrum 220 and optical spectrum 222 may result in a second beat note in the photocurrent produced by detector 210.

In an example, the electrical signal 226 may be received at controller 216. In an example, controller 216 may detect the beat note(s) mentioned above. In an example, controller 216 may produce an error signal for detected beat note(s). That is, the beat note as a result of heterodyne mixing of f/2f spectra may correspond to the f_{CEO} 212, and the controller 216 may produce an error signal (e.g., using a P-I-D or any other suitable error scheme) for f_{CEO} 212. Similarly, second beat note may correspond to the f_{Opt} 214, and the controller 216 may produce an error signal (e.g., using a P-I-D or any other suitable error scheme) for f_{Opt} 214.

As seen in FIG. 2, a first control loop may include closed-loop feedback to lock f_{CEO} 212 at a setpoint. Tracing through the system 200, the first control loop can comprise:
i) frequency comb oscillator 202 outputting the pulse train having optical spectrum 218, ii) f/2f generation 206 having optical spectrum 220,
iii) heterodyne detection of the optical spectrum 220 at detector 210, producing electrical signal 226,
iv) beat note detection of f_{CEO} 212 at controller 216,
v) error signal generation at controller 216, and
vi) error signal input (e.g., via electrical signal 228) to the frequency comb oscillator 202.

As seen in FIG. 2, the second control loop may include closed-loop feedback to lock f_{Opt} 214 at a specified setpoint. Tracing through the system 200, the second control loop can comprise:
i) frequency stabilized optical reference 208 having optical spectrum 222;
ii) combining the optical spectrum 222 with optical spectrum 220;
iii) heterodyne detection of the combined optical spectrum 222 and optical spectrum 220, producing electrical signal 226,
iv) beat note detection of f_{Opt} 214 at controller 216,
v) error signal generation at controller 216,
vi) error signal input (e.g., via electrical signal 230) to the frequency comb oscillator 202.

In listing out the components for the first control loop and the second control loop, it may be seen that the portion of the first control loop path comprising heterodyne detection can be shared with the second control loop path. By using an element common to both control loop paths, the beat notes for f_{CEO} 212 and f_{Opt} 214 are carried on the same electrical signal 226.

FIG. 3 illustrates a block diagram for a system 300 providing frequency comb stabilization using combined detection. The system 300 produces a frequency comb spectrum 328 and comprises a pulsed laser 302 that may produce short optical pulses (e.g., 100-300 femtoseconds at 1556 nm) at a well-controlled frequency (e.g., fᵣₑₚ of 100 MHz, 1 GHZ, etc.).

The short optical pulses having frequency comb spectrum 328 may optionally be amplified in an optical amplifier 304. For example, a 100 micro-Watt input pulse may have an average power increased to 30 mW using an Erbium doped fiber amplifier, which may maintain the pulse shape (e.g., Gaussian, sinc, sech, etc.) and the center frequency of the pulse. A pump laser 306 (e.g., diode laser) may be used to provide optical energy for the pulsed laser 302 and the optical amplifier 304. In an example, the pump laser 306 may be optically connected to one or more variable optical attenuators (e.g., continuously variable filter wheels, set(s) of discrete filters, fiber optic attenuators, etc.) configured to deliver respective amounts of optical power from the pump laser 306 to the pulsed laser 302 (e.g., frequency comb oscillator) and from the pump laser 306 to the optical amplifier 304. In some examples, optical amplifier 304 may output an amplified frequency comb spectrum 330. Note that additional componentry, such as dispersion compensating fiber optic cables, may be included in system 300.

In some examples, an optical combiner 308 may combine the amplified frequency comb spectrum 330 (or, optionally, the frequency comb spectrum 328 when optical amplifier 304 is not used) with an optical reference spectrum 332. For example, an optical reference spectrum 332 may be derived from a frequency stabilized optical reference 316 that uses an atomic or molecular energy transition, as described in FIG. 1. As a particular example, the frequency stabilized optical reference 316 is a continuous-wave (CW) laser that is frequency-locked to an Rb transition which fluoresces at about 778 nm. In other examples, the optical reference spectrum 332 may be derived from a stabilized CW cavity source (e.g., having a hyperfine transition) or any other suitable optical reference. In some examples, the optical reference spectrum 332 may have a different center wavelength from the frequency comb spectrum 328.

The optical combiner 308 may output combined spectra 334. The combined spectra 334 may be input to one or more optical nonlinear components 314 that have non-linear terms in the material response (e.g., second-order or third-order terms in electric susceptibility). In one example, the nonlinear components 314 may include a frequency broadening component. As a particular example, the frequency broadening component may increase the bandwidth of the frequency comb spectra to be at least one octave (e.g., where the highest frequency in the broadened spectrum is approximately double that of the lowest frequency in the broadened spectrum).

In another example, the nonlinear components 314 may include a frequency doubling component. The nonlinear components 314 may include optical fibers, optical waveguides in a photonic integrated circuit, etc. Materials having nonlinear terms in the material response include Ta2O5, Si3N4, periodically poled lithium niobate (PPLN), etc., and may have any suitable dimensions (e.g., propagation length) to provide an output spectrum that is frequency doubled from an input spectrum, and in an example, that is frequency broadened (e.g., to cover an octave span) from an input spectrum.

Nonlinear components 314 output optical spectra 336 having three components—the frequency broadened spectrum that originated from the comb spectrum, the frequency doubled spectrum that originated from the comb spectrum, and the optical reference spectrum 332.

An optical filter 310 may optionally be used to filter out wavelengths from optical spectra 336 that are outside a wavelength (frequency) band of interest prior to the optical spectra 336 being incident on the detector 312.

Optical heterodyne detection may use a detector 312 (e.g., photodetector, photodiode) to electronically record beat notes between the component spectra of optical spectra 336. The detector may be configured to output an electrical signal 340 (e.g., photocurrent) in response to the combined optical spectra 336 being incident on the detector 312. The electrical signal 340 has multiple heterodyne signals within the RF output, which may be used in combination with a controller 326.

The optical heterodyne technique may further comprise using a controller 326 (e.g., proportional-integral-derivative PID controller, FPGA processor, etc.) having at least one beat note detector, which may be configured to detect multiple beat notes in the photocurrent. For example, the controller 326 may have a processor configured to detect the carrier offset frequency f_{CEO} 320 as a first beat note between the frequency broadened spectrum that originated from the comb spectrum and the frequency doubled spectrum that originated from the comb spectrum. In another example, the controller 326 may have a processor configured to detect f_{Opt} 322 as a second beat note between the frequency broadened spectrum that originated from the comb spectrum and the optical reference spectrum 332. In some examples, controller 326 may include any suitable electronic filtering (e.g., RF bandpass filters at respective frequencies) to detect the respective beat notes. The beat notes f_{CEO} 320 and f_{Opt} 322 may be at much lower frequency than optical frequencies and may be in a radio- or microwave-frequency range (e.g., kHz to GHz).

The controller 326 may output respective electrical control signals 342 and 344 based on the detected beat notes. For example, the controller 326 may store pre-determined setpoints for the beat notes f_{CEO} 320 and f_{Opt} 322, and may compare the beat notes received in the electrical signal 340 with the pre-determined setpoints in order to determine respective error signals. Error signals may be determined using any suitable setpoint criteria, such as proportional-integral-derivative (PID) controls.

The electrical control signals 342 and 344 may be sent to the frequency comb oscillator (e.g., pulsed laser 302). For example, electrical control signal 342 may be used to steer a spectral component of the frequency comb spectra by adjusting a cavity length of the frequency comb oscillator, adjusting a temperature of a laser diode in the frequency comb oscillator, etc. Additionally, in some examples, electrical control signal 344 may be used to steer the carrier offset frequency of the comb spectra by providing adjustments to the pump current of pump laser 306.

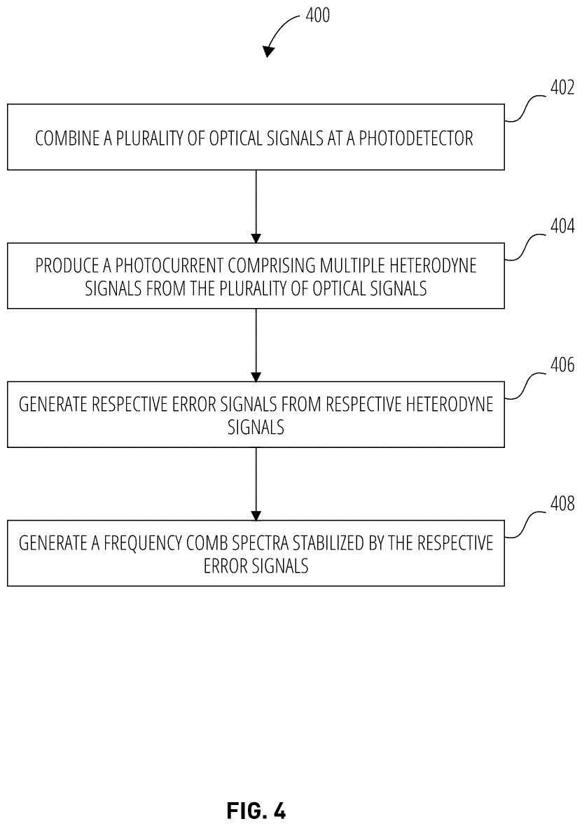

FIG. 4 illustrates a method 400 for generating and stabilizing frequency comb signals. The method can include combining optical signals at a photodetector (402), producing a photocurrent comprising multiple heterodyne signals (404), generating respective error signals from the heterodyne signals (406), and generating a frequency comb spectrum stabilized by the error signals (408). The method enables generation of both f_{CEO} and f_{Opt} beat notes from a single detector.

At 402, the method 400 may include combining a plurality of optical signals at a photodetector, where the optical signals comprise: a first optical spectrum generated using a spectrum broadening optical component that receives an optical pulse output from a frequency comb oscillator; a second optical spectrum generated using a frequency doubling optical component; and a third optical spectrum received from a frequency-stabilized optical reference.

At 404, the method 400 may include producing a photocurrent comprising multiple heterodyne signals from the combined optical signals, wherein the heterodyne signals include a first heterodyne signal determined from mixing the first optical spectrum and the second optical spectrum to generate an f_{CEO} beat signal, and a second heterodyne signal determined from mixing the first optical spectrum and the third optical spectrum to generate an f_{Opt} beat signal.

At 406, the method 400 may include generating respective error signals from the heterodyne signals, including generating a first error signal based on the f_{CEO} beat signal and a second error signal based on the f_{Opt} beat signal.

At 408, the method 400 may include generating a frequency comb spectrum stabilized by the error signals, wherein the first error signal is input to the frequency comb oscillator to stabilize a carrier-offset frequency of the frequency comb spectrum, and the second error signal is input to stabilize a spectral component of the frequency comb spectrum. The stabilization involves determining frequency setpoints based on minimizing interference between the beat signals while maintaining separation from locking dead zones.

The method 400 may further include determining criteria for the frequency setpoints to avoid interference between RF beat frequencies, avoid locking dead zones, and achieve a target repetition rate fᵣₑₚ. The criteria may be based on a mathematical optimization that considers the relationships between f_{CEO}, f_{Opt} and the repetition rate fᵣₑₚ.

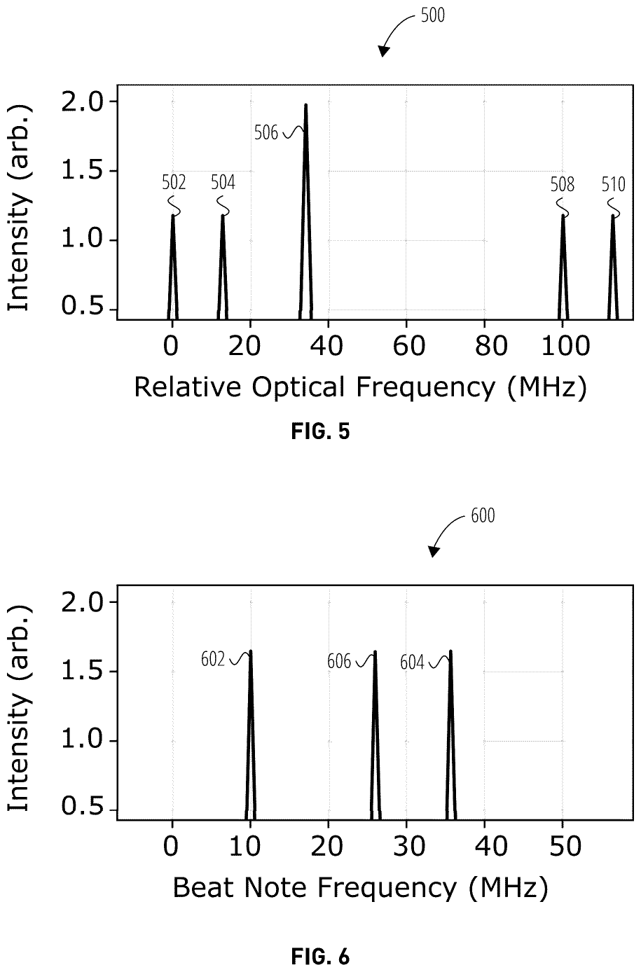

FIG. 5 illustrates relative optical frequency spectra, showing the spectral components used for generating heterodyne signals in an example. FIG. 6 illustrates a graph of the heterodyne signals between the spectral components shown in FIG. 5.

The graph 500 comprises optical spectrum showing the relative frequency offsets of a comb tooth 502, a frequency doubled comb tooth 504, an optical reference 506, a comb tooth 508, and a frequency double comb tooth 510.

In an example, a beat note between comb tooth 502 and frequency doubled comb tooth 504 may provide a heterodyne electrical signal at the frequency f_{CEO}, as shown by beat note 602. In an example, the beat note between comb tooth 502 and optical reference 506 may provide a heterodyne electrical at the frequency f_{Opt} as shown by beat note 604. In an example, these two frequencies may be selectable according to at least one criterion. In an example, a beat note between comb tooth 502 and comb tooth 508 may provide an output electrical clock signal at fᵣₑₚ.

In an example, the criteria may include that neither f_{CEO} nor f_{Opt} are too close to DC (0 MHz) as the electrical signals may include technical noise from the lasers and electronics. In an example, neither f_{CEO} nor f_{Opt} may be too close to fᵣₑₚ/2 to avoid a reflection signal at the difference frequencies of (fᵣₑₚ−f_{CEO}) or (fᵣₑₚ−f_{Opt}). That is, if the reflection signal is too close to fᵣₑₚ/2, the controller 216 may not be able to provide a stable error signal. A separation of approximately 3 MHz between f_{CEO}, f_{Opt}, and fᵣₑₚ/2 may be sufficient.

In some examples, due to the optical frequency reference (e.g., a frequency of a Rubidium clock transition), for fᵣₑₚ to be exactly 100 MHz, there may be constraint, such as shown in Eq. 1:

$${f}_{ceo} + {f}_{opt} = 45.67 MHz \qquad Eq . ( 1 )$$

Other optical clocks may have similar constraints with different numerical values depending on the atomic transition used and the specified clock frequency fᵣₑₚ output by the frequency comb.

In addition to the beat notes described above, a beat note 606 at the difference frequency |f_{CEO}−fₒₚₜ| also appears in the RF signal. In addition to the above criteria, additional criteria may include:

$${f}_{ceo} \neq {f}_{opt} \qquad Eq . ( 2 )$$

$$\vert {f}_{ceo} - {f}_{opt} \vert \neq {f}_{opt} \qquad Eq . ( 3 )$$

$$\vert {f}_{ceo} - {f}_{opt} \vert \neq {f}_{ceo} \qquad Eq . ( 4 )$$

The first criterium (Eq. (2)) can serve to provide sufficient separation between f_{CEO} and f_{Opt}, while the latter two criteria (Eq. (3) and (4) can serve to provide sufficient separation between the difference frequency and f_{Opt} or f_{CEO}.

In an example, the criteria may be combined in a mathematical expression, such as

$$F = \frac{1}{\vert {f}_{Opt} \vert} + \frac{1}{\vert {f}_{CEO} \vert} + \frac{1}{\vert {f}_{Opt} - \frac{{f}_{rep}}{2} \vert} + \frac{1}{\vert {f}_{CEO} - \frac{{f}_{rep}}{2} \vert} + 1 / \vert ( {f}_{CEO} - \vert {f}_{CEO} - {f}_{Opt} \vert ) \vert + 1 / \vert ( {f}_{Opt} - \vert {f}_{CEO} - {f}_{Opt} \vert ) \vert \qquad Eq . ( 5 )$$

The mathematical expression may be analyzed, e.g., by minimizing the value of F, as defined in Eq. (5). In an example, the output quantity F may have a minimum value when f_{CEO}=9.6 MHz as shown by beat note 602, and f_{Opt}=36.07 MHz as shown by beat note 604. Swapping the two frequencies is also a viable approach.

In another example, the mathematical expression may include square distances instead of linear distances.

In summary, the criteria used with the spectra in FIG. 5 and FIG. 6 may include:
Each of f_{CEO} and f_{Opt} maintains at least 3 MHz separation from DC and fᵣₑₚ/2;
f_{CEO} and f_{Opt} maintain sufficient separation from each other to avoid interference;
The difference frequency |f_{Opt}−f_{CEO}| remains distinct from both f_{CEO} and f_{Opt}; and
The sum f_{CEO}+f_{Opt} equals 45.67 MHz (or any other value as set by the optical reference) to achieve the target repetition rate fᵣₑₚ.

FIG. 7 illustrates an optical spectrum broadened by a nonlinear optical component. For example, as discussed above in FIG. 2 and FIG. 3, a frequency comb spectrum (solid line) may be input to an optical component that broadens the frequency comb spectra, ideally to at least an octave span (e.g., factor of 2 between the lowest frequency and the highest frequency). The broadened spectrum is shown in the dotted line and may be used for self-referencing techniques to measure the f_{CEO}.

In the graph shown, the power spectral density (PSD) is shown in dBm/nm against both frequency (THz) and wavelength (nm) axes. The graph demonstrates the octave-spanning spectrum generated by the system, covering approximately 750-2000 nm.

Example 1 is a system for stabilizing a frequency comb, the system comprising: a frequency comb oscillator configured to produce optical pulses having a frequency comb spectrum; a first control loop having a first radio frequency (RF) setpoint and configured to stabilize a carrier offset frequency of the frequency comb spectrum at the first RF setpoint; a second control loop having a second RF setpoint and configured to stabilize a spectral component of the frequency comb spectrum at the second RF setpoint; and a photodetector shared by the first control loop and the second control loop, the photodetector configured to receive respective optical signals from respective control loops, wherein in response to receiving the respective optical signals, the photodetector produces an electrical RF signal comprising multiple electronic heterodyne signals to be used by the respective control loops.

In Example 2, the subject matter of Example 1 includes, wherein the first control loop comprises: optical componentry to deliver a first optical spectrum to the photodetector, the first optical spectrum generated from a spectrum broadening optical component that receives an optical pulse output from the frequency comb oscillator; optical componentry to deliver a second optical spectrum to the photodetector, the second optical spectrum generated from a frequency doubling optical component that receives one of: the optical pulse output from the frequency comb oscillator or the first optical spectrum; a first error determination circuit, configured to generate a first electronic error signal based on a first heterodyne signal produced from mixing the first optical spectrum and the second optical spectrum using the photodetector; and a carrier offset frequency stabilization circuit configured to use the first electronic error signal to stabilize the carrier offset frequency of the frequency comb spectrum.

In Example 3, the subject matter of Example 2 includes, an optical amplifier that amplifies the optical pulse output from the frequency comb oscillator and outputs an amplified optical pulse, and wherein the first optical spectrum is generated from a spectrum broadening optical component that receives the amplified optical pulse.

In Example 4, the subject matter of Example 3 includes, a diode laser that is configured to pump the frequency comb oscillator and the optical amplifier.

In Example 5, the subject matter of Examples 2-4 includes, wherein the second control loop comprises: optical componentry to deliver the first optical spectrum to the photodetector; optical componentry to deliver a third optical spectrum to the photodetector, the third optical spectrum received from a frequency-stabilized optical reference; a second error determination circuit, configured to generate a second electronic error signal based on a second heterodyne signal produced from mixing the first optical spectrum and the third optical spectrum using the photodetector; and a stabilization circuit configured to use the second electronic error signal to stabilize the spectral component of the frequency comb spectrum.

In Example 6, the subject matter of Example 5 includes, wherein the frequency-stabilized optical reference is frequency-locked to an atomic or molecular energy transition.

In Example 7, the subject matter of Examples 5-6 includes, a shared optical componentry carrier to carry optical componentry generating the first optical spectrum, the second optical spectrum, and the third optical spectrum.

In Example 8, the subject matter of Examples 5-7 includes, optical componentry to combine the third optical spectrum with the optical pulse output from the frequency comb such that the third optical spectrum passes unaffected through: the spectrum broadening optical component and the frequency doubling optical component.

In Example 9, the subject matter of Examples 5-8 includes, wherein the first RF setpoint and the second RF setpoint are selected such that a frequency of optical pulses being output from the frequency comb oscillator are at a target RF value.

Example 10 is a method for generating a frequency comb spectrum, the method comprising: combining a plurality of optical signals at a photodetector, the plurality of optical signals comprising: a first optical spectrum generated using a spectrum broadening optical component that receives an optical pulse output from a frequency comb oscillator; a second optical spectrum generated using a frequency doubling optical component that receives one of: the optical pulse output from the frequency comb oscillator or the first optical spectrum; and a third optical spectrum received from a frequency-stabilized optical reference; in response to combining the plurality of optical signals at the photodetector, producing an electrical signal comprising multiple heterodyne signals at respective frequencies; generating a first error signal based on a first heterodyne signal in the multiple heterodyne signals, the first heterodyne signal determined based on the first optical spectrum and the second optical spectrum; generating a second error signal based on a second heterodyne signal in the multiple heterodyne signals, the second heterodyne signal determined based on the first optical spectrum and the third optical spectrum; and generating, from the frequency comb oscillator, a frequency comb spectrum comprising a pulse train output at a repetition rate, wherein the first error signal is input to the frequency comb oscillator to stabilize a carrier-offset frequency of the frequency comb spectrum, and the second error signal is input to the frequency comb oscillator to stabilize a spectral component of the frequency comb spectrum.

In Example 11, the subject matter of Example 10 includes, wherein the optical pulse output from the frequency comb oscillator is optically amplified to output an amplified optical pulse, and wherein the first optical spectrum is generated from a spectrum broadening optical component that receives the amplified optical pulse.

In Example 12, the subject matter of Example 11 includes, wherein a diode laser is configured to pump the frequency comb oscillator and an optical amplifier, the diode laser optically connected to one or more variable optical attenuators configured to deliver respective amounts of optical power from the diode laser to the frequency comb oscillator and from the diode laser to the optical amplifier.

In Example 13, the subject matter of Examples 10-12 includes, wherein the frequency-stabilized optical reference is frequency-stabilized to an atomic or molecular energy transition.

In Example 14, the subject matter of Examples 10-13 includes, determining one or more criteria for individual ones of a plurality of frequency setpoints, the frequency setpoints respectively configured to operate corresponding control loops for stabilizing the frequency comb spectrum.

In Example 15, the subject matter of Example 14 includes, generating criteria represented by a mathematical expression comprising:

$$F = \frac{1}{\vert {f}_{Opt} \vert} + \frac{1}{\vert {f}_{CEO} \vert} + \frac{1}{\vert {f}_{Opt} - \frac{{f}_{rep}}{2} \vert} + \frac{1}{\vert {f}_{CEO} - \frac{{f}_{rep}}{2} \vert} + 1 / \vert ( {f}_{CEO} - \vert {f}_{CEO} - {f}_{Opt} \vert ) \vert + 1 / \vert ( {f}_{Opt} - \vert {f}_{CEO} - {f}_{Opt} \vert ) \vert ;$$

determining the plurality of frequency setpoints based on a minimization of the mathematical expression; and operating the frequency comb oscillator with the determined frequency setpoints.

In Example 16, the subject matter of Examples 14-15 includes, wherein the criteria comprise a sum of a first frequency setpoint and a second frequency setpoint that is related to the repetition rate.

In Example 17, the subject matter of Examples 14-16 includes, wherein the criteria are based on respective frequency setpoints that are unequal.

In Example 18, the subject matter of Examples 14-17 includes, wherein the criteria comprise that an absolute value of a difference between a first frequency setpoint and a second frequency setpoint that is unequal to either of the first frequency setpoint and the second frequency setpoint.

In Example 19, the subject matter of Examples 14-18 includes, wherein the criteria comprise that respective frequency setpoints are offset from a harmonic of the repetition rate.

Example 20 is a frequency comb system, the system comprising: a frequency comb oscillator configured to: receive a first RF signal that frequency-locks a carrier offset frequency of a frequency comb output by the frequency comb oscillator; receive a second RF signal that frequency-locks a spectral component of the frequency comb; and output an optical pulse at a repetition rate stabilized by the frequency-locked carrier offset frequency and the frequency-locked spectral component; an optical reference having a frequency-stabilized continuous wave optical output; a non-linear optical component comprising: a spectrum broadening optical component that receives an optical pulse output from the frequency comb oscillator and outputs a first optical spectrum; and a frequency-doubling optical component that outputs a frequency-doubled spectrum based on an input spectrum, wherein the input spectrum is one of: an optical pulse from the frequency comb oscillator or the first optical spectrum; a photodetector configured to: receive the first optical spectrum, the frequency-doubled spectrum and the continuous wave optical output, in response to which the photodetector produces an RF electrical signal comprising: a first heterodyne signal produced from mixing the first optical spectrum and the frequency-doubled spectrum at the photodetector; and a second heterodyne signal produced from mixing the first optical spectrum and the continuous wave optical output at the photodetector; and an electronic control circuit, coupled to the photodetector to receive the first heterodyne signal and the second heterodyne signal, the electronic control circuit comprising: a first error determination circuit, configured to generate the first RF signal; and a second error determination circuit, configured to generate the second RF signal.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Other technical features and example embodiments may be readily apparent to one skilled in the art from the figures, descriptions, and claims herein.

A detailed description of one or more embodiments of the invention is provided above along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the preceding description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

It can be understood that, although the terms first, second, etc. are, in some instances, used herein to describe various elements, these elements should not be limited by these terms. These terms are used only to distinguish one element from another. For example, a first tuner could be termed a second tuner, and, similarly, a second tuner could be termed a first tuner, without departing from the scope of the various described embodiments. The first tuner and the second tuner are both tuners, but they are not the same tuner.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A system for stabilizing a frequency comb, the system comprising:
a frequency comb oscillator configured to produce optical pulses having a frequency comb spectrum;
a first control loop having a first radio frequency (RF) setpoint and configured to stabilize a carrier offset frequency of the frequency comb spectrum at the first RF setpoint;
a second control loop having a second RF setpoint and configured to stabilize a spectral component of the frequency comb spectrum at the second RF setpoint; and
a photodetector shared by the first control loop and the second control loop, the photodetector configured to receive respective optical signals from respective control loops, wherein in response to receiving the respective optical signals, the photodetector produces an electrical RF signal comprising multiple electronic heterodyne signals to be used by the respective control loops.

2. The system of claim 1, wherein the first control loop comprises:
optical componentry to deliver a first optical spectrum to the photodetector, the first optical spectrum generated from a spectrum broadening optical component that receives an optical pulse output from the frequency comb oscillator;
optical componentry to deliver a second optical spectrum to the photodetector, the second optical spectrum generated from a frequency doubling optical component that receives one of: the optical pulse output from the frequency comb oscillator or the first optical spectrum;
a first error determination circuit, configured to generate a first electronic error signal based on a first heterodyne signal produced from mixing the first optical spectrum and the second optical spectrum using the photodetector; and
a carrier offset frequency stabilization circuit configured to use the first electronic error signal to stabilize the carrier offset frequency of the frequency comb spectrum.

3. The system of claim 2, comprising an optical amplifier that amplifies the optical pulse output from the frequency comb oscillator and outputs an amplified optical pulse, and wherein the first optical spectrum is generated from a spectrum broadening optical component that receives the amplified optical pulse.

4. The system of claim 3, comprising a diode laser that is configured to pump the frequency comb oscillator and the optical amplifier.

5. The system of claim 2, wherein the second control loop comprises:
optical componentry to deliver the first optical spectrum to the photodetector;
optical componentry to deliver a third optical spectrum to the photodetector, the third optical spectrum received from a frequency-stabilized optical reference;
a second error determination circuit, configured to generate a second electronic error signal based on a second heterodyne signal produced from mixing the first optical spectrum and the third optical spectrum using the photodetector; and
a stabilization circuit configured to use the second electronic error signal to stabilize the spectral component of the frequency comb spectrum.

6. The system of claim 5, wherein the frequency-stabilized optical reference is frequency-locked to an atomic or molecular energy transition.

7. The system of claim 5, further comprising a shared optical componentry carrier to carry optical componentry generating the first optical spectrum, the second optical spectrum, and the third optical spectrum.

8. The system of claim 5, further comprising optical componentry to combine the third optical spectrum with the optical pulse output from the frequency comb such that the third optical spectrum passes unaffected through: the spectrum broadening optical component and the frequency doubling optical component.

9. The system of claim 5, wherein the first RF setpoint and the second RF setpoint are selected such that a frequency of optical pulses being output from the frequency comb oscillator are at a target RF value.

10. A method for generating a frequency comb spectrum, the method comprising:
combining a plurality of optical signals at a photodetector, the plurality of optical signals comprising:
a first optical spectrum generated using a spectrum broadening optical component that receives an optical pulse output from a frequency comb oscillator;
a second optical spectrum generated using a frequency doubling optical component that receives one of: the optical pulse output from the frequency comb oscillator or the first optical spectrum; and
a third optical spectrum received from a frequency-stabilized optical reference;
in response to combining the plurality of optical signals at the photodetector, producing an electrical signal comprising multiple heterodyne signals at respective frequencies;
generating a first error signal based on a first heterodyne signal in the multiple heterodyne signals, the first heterodyne signal determined based on the first optical spectrum and the second optical spectrum;
generating a second error signal based on a second heterodyne signal in the multiple heterodyne signals, the second heterodyne signal determined based on the first optical spectrum and the third optical spectrum; and
generating, from the frequency comb oscillator, a frequency comb spectrum comprising a pulse train output at a repetition rate, wherein the first error signal is input to the frequency comb oscillator to stabilize a carrier-offset frequency of the frequency comb spectrum, and the second error signal is input to the frequency comb oscillator to stabilize a spectral component of the frequency comb spectrum.

11. The method of claim 10, wherein the optical pulse output from the frequency comb oscillator is optically amplified to output an amplified optical pulse, and wherein the first optical spectrum is generated from a spectrum broadening optical component that receives the amplified optical pulse.

12. The method of claim 11, wherein a diode laser is configured to pump the frequency comb oscillator and an optical amplifier, the diode laser optically connected to one or more variable optical attenuators configured to deliver respective amounts of optical power from the diode laser to the frequency comb oscillator and from the diode laser to the optical amplifier.

13. The method of claim 10, wherein the frequency-stabilized optical reference is frequency-stabilized to an atomic or molecular energy transition.

14. The method of claim 10, further comprising:
determining one or more criteria for individual ones of a plurality of frequency setpoints, the frequency setpoints respectively configured to operate corresponding control loops for stabilizing the frequency comb spectrum.

15. The method of claim 14, comprising:
generating criteria represented by a mathematical expression comprising:
$$F = \frac{1}{\vert {f}_{Opt} \vert} + \frac{1}{\vert {f}_{CEO} \vert} + \frac{1}{\vert {f}_{Opt} - \frac{{f}_{rep}}{2} \vert} + \frac{1}{\vert {f}_{CEO} - \frac{{f}_{rep}}{2} \vert} + 1 / \vert ( {f}_{CEO} - \vert {f}_{CEO} - {f}_{Opt} \vert ) \vert + 1 / \vert ( {f}_{Opt} - \vert {f}_{CEO} - {f}_{Opt} \vert ) \vert ;$$
determining the plurality of frequency setpoints based on a minimization of the mathematical expression; and
operating the frequency comb oscillator with the determined frequency setpoints.

16. The method of claim 14, wherein the criteria comprise a sum of a first frequency setpoint and a second frequency setpoint that is related to the repetition rate.

17. The method of claim 14, wherein the criteria are based on respective frequency setpoints that are unequal.

18. The method of claim 14, wherein the criteria comprise that an absolute value of a difference between a first frequency setpoint and a second frequency setpoint that is unequal to either of the first frequency setpoint and the second frequency setpoint.

19. The method of claim 14, wherein the criteria comprise that respective frequency setpoints are offset from a harmonic of the repetition rate.

20. A frequency comb system, the system comprising:
a frequency comb oscillator configured to:
receive a first RF signal that stabilizes a carrier offset frequency of a frequency comb output by the frequency comb oscillator;
receive a second RF signal that stabilizes a spectral component of the frequency comb; and
output an optical pulse at a repetition rate stabilized by the frequency-locked carrier offset frequency and the frequency-locked spectral component;
an optical reference having a frequency-stabilized continuous wave optical output;
a non-linear optical component comprising:
a spectrum broadening optical component that receives an optical pulse output from the frequency comb oscillator and outputs a first optical spectrum; and
a frequency-doubling optical component that outputs a frequency-doubled spectrum based on an input spectrum, wherein the input spectrum is one of: an optical pulse from the frequency comb oscillator or the first optical spectrum;
a photodetector configured to:
receive the first optical spectrum, the frequency-doubled spectrum and the continuous wave optical output, in response to which the photodetector produces an RF electrical signal comprising:
a first heterodyne signal produced from mixing the first optical spectrum and the frequency-doubled spectrum at the photodetector; and
a second heterodyne signal produced from mixing the first optical spectrum and the continuous wave optical output at the photodetector; and
an electronic control circuit, coupled to the photodetector to receive the first heterodyne signal and the second heterodyne signal, the electronic control circuit comprising:
a first error determination circuit, configured to generate the first RF signal; and
a second error determination circuit, configured to generate the second RF signal.
